(19) United States
(12) Patent Application Publication
(10) Pub. No.: US 2010/0057523 A1
(43) Pub. Date: Mar. 4, 2010

(54) METHOD FOR OPTIMIZATION OF THE DETERMINATION OF THE ACTUAL PERSONNEL REQUIREMENTS FOR CREATION OF A DUTY ROSTER FOR A HOTEL, A GUESTHOUSE, AND/OR A RESTAURANT

(76) Inventors: Guenther Weiss, Rodenbach (DE); Dzmitry Ilyin, Rodenbach (DE)

Correspondence Address: K.F. ROSS P.C., 5683 RIVERDALE AVENUE, SUITE 203 BOX 900, BRONX, NY, 10471-0900, US

(21) Appl. No.: 12/523,075

(22) PCT Filed: Jan. 15, 2008
(86) PCT No.: PCT/EP08/00248

§ 371 Date: Jul. 14, 2009

(30) Foreign Application Priority Data
Jan. 19, 2007 (DE) 10 2007 002 950.2

(51) Int. Cl. G06Q 10/00; G06Q 50/00

(52) U.S. Cl. 705/9; 705/301

(57) ABSTRACT

Method for optimization of the determination of the actual personnel requirement for creation of a service plan for a hotel, a guesthouse and/or a restaurant with the aid of a data processing system having a memory, a processor, at least one input unit, at least one interface to a reservation program and a budget planning program as well as a common user interface, with the method comprising the following steps: a) storage of employee data, including individual employee characteristics, b) storage of department-specific requirements and/or event-dependent requirements, c) immediate entry of those absent, d) inclusion of data relating to current occupancy via the interface to a reservation program and to a budget planning program, e) determination of the actual or current personnel requirement, or the personnel required for a time period which can be defined, on the basis of the required employee hours per department, with the aid of department-specific formulae based on the data from the method steps a) to d) and f) display of a report on the common user interface.

The invention relates to a method of determining actual personnel requirements for creation of a duty roster for a hotel, a guesthouse, and/or a restaurant with the aid of a data-processing system having a memory, a processor, at least one input unit, at least one interface to a reservation program and a budgeting program, as well as a common user interface.

Hotel management in particular absolutely requires efficient, detailed, and time-accurate personnel scheduling to ensure smooth, service-oriented operation. In the event of high occupancy, understaffing would result in poor service, whereas overstaffing is not cost-effective.

To this day, duty rosters are often created manually, that is, with paper and pencil. Proper planning for service-oriented operations is very complex or not possible by this approach. It is also not possible to integrate sudden changes on short notice, such as, for example, employee absences, into this type of system.

In the published utility model DE 20 2004 010 150, an information display to display duty rosters is described that can visually present duty rosters on a special external information display composed of aluminum having name badges and control LEDs.

DE 101 36 054 discloses a method that uses a computer to generate and manage duty rosters or shift schedules for work scheduling. Here a user interface is divided up into a menu bar, toolbar, spreadsheet, and status bar, the spreadsheet containing the days and names of employees and also being divided into the fields of proposed shifts, scheduled shifts, shifts actually performed, and comments. However, this known method does not allow for any integration of data from a reservation program and thus determination of actual personnel requirements.

The object to be attained by this invention is thus to provide a method of optimizing the determination of actual personnel requirements for the creation of a duty roster, in which a uniform duty roster organization for multiple departments is provided, the data can be retrieved at any time, and the object is to provide automatic adjustment of the capacity utilization of a service-oriented operation.

The problem is solved according to the invention by a method of optimizing the determination of actual personnel requirements for the creation of a duty roster of a hotel, guesthouse, and/or restaurant with the aid of a data-processing system having a memory, a processor, at least one input unit, at least one interface to a reservation program and a budgeting program, as well as a common user interface, wherein the method comprises the following steps:
a) storing employee data, including individual employee properties;
b) storing department-specific needs and/or event-dependent requirements;
c) immediately entering absence data;
d) integrating data on current occupancy through an interface to a reservation program and to a budgeting program;
e) determining the actual current personnel requirement, or that required for a specifiable time period, based on the required employee hours per department with the aid of department-specific formulas and utilizing the data from method steps a) through d); and
f) generating a report on the common user interface.

This type of method produces a simplification of the organization of a duty roster, the actual personnel requirement being determinable by utilizing the actual current hotel occupancy. As a result, duty rosters can be created uniformly across departments, and quickly and flexibly adapted to the given current conditions. This provides an enormous savings in terms of time and expense, and ultimately results in efficient personnel scheduling and an increase in productivity over the long term. In addition, overstaffing and understaffing, as well as overtime levels, can be avoided on a long-term basis. Another advantage results from the ability uniformly and on short notice to generate reports to management.

In an advantageous embodiment of the method according to the invention, the employee data are imported through an interface from a database of the personnel department, and/or entered manually. In an advantageous development, the attendance data for employees is integrated in the data-processing system through a time-recording system, and/or entered manually.

In addition, it is advantageous that the department-specific and/or event-dependent requirements stored in the database can be modified by the relevant department as required. It is furthermore advantageous to display warning messages when overstaffing and/or understaffing is detected. It is furthermore advantageous if the language of the user interface can be freely selected by the specific user.

In an advantageous embodiment of the invention, calendar summaries of absent employees are displayed by department, name, and/or personnel number. In an advantageous development of the method according to the invention, new employee profiles are added manually to the database, or existing employee profiles are updated to include additional individual employee properties. An interface to the Internet can be advantageous in that a report can also be provided to management, for example, independently of location.

Furthermore, a computer program comprising programming code to implement all of the method steps according to the invention is advantageous if this type of program is to be executed in a computer. In addition, such a computer program comprising programming code can be utilized to perform the method steps according to the invention, the programming code being stored on a machine-readable medium.

The following discussion describes the invention in more detail based on multiple figures. Therein:

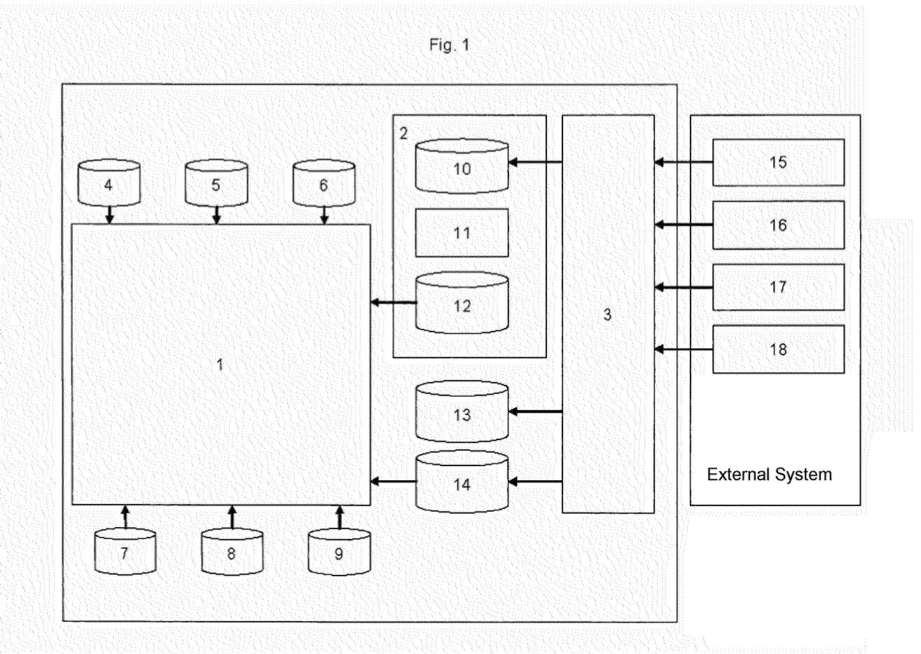

FIG. 1 is a schematic view illustrating the method according to the invention; and

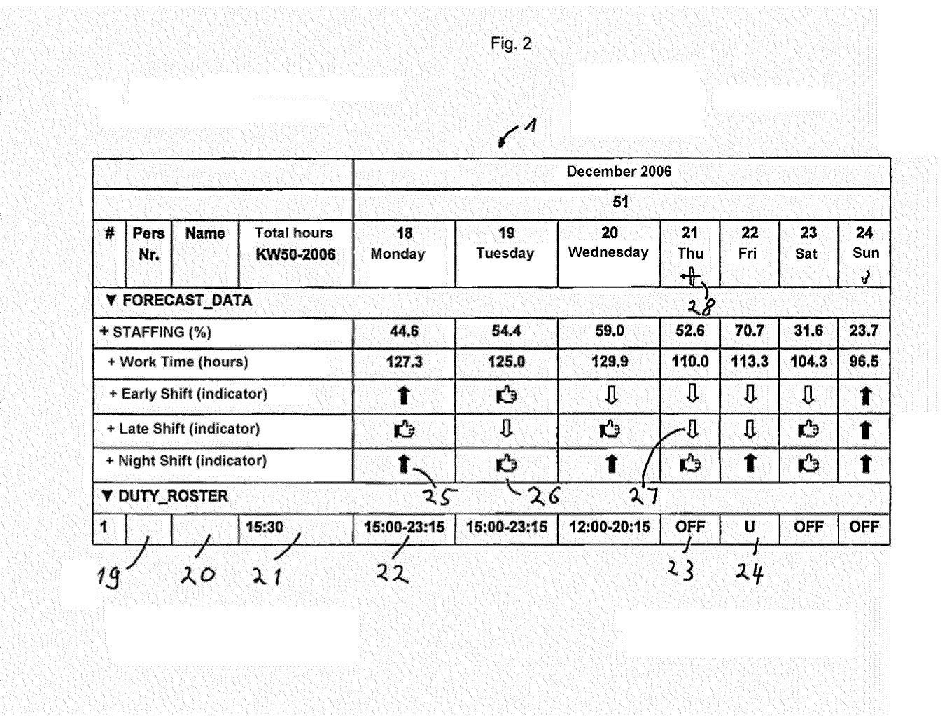

FIG. 2 is a summary diagram of a duty roster.

FIG. 1 schematically illustrates an advantageous embodiment according to the invention. Here an interface feeds reservation data 15, personnel data 16, time-recording data 17 from a time-recording system, and budgeting data 18 for data import from external systems into a forecast module 2. In the forecast module 2, the imported input data 10 are further processed by department-specific formulas 11. The hours 12 projected as a function of the design serve as a data record to generate the duty roster 1. Furthermore, employee data 13 as well as the hours 14 actually worked are used to generate the duty roster 1. In addition, data relating to holidays or fairs 4, data on employees available on short notice in the form of market place 5, as well as specific hourly requirements 6 in the form of special requirements, are all utilized together to generate duty roster 1. In addition, an integration is effected of employee overtime through time account 7, of absence data 8, such as, for example, vacation or sick days, as well as schedule data 9 on hours to be worked.

In FIG. 2, a duty roster 1 is illustrated by way of example in a summary view. What is shown here as a weekly summary view, where in each case one name 20 of an employee, one time account 21, one working hours 22, free days 23, and absences 24 can be allocated to one personnel number 19. The display shows certain indicators in the top section for the various shifts as well as the projected status for each day for a given scheduling. There is thus one indicator 25 for over-scheduling one indicator 26 for optimum scheduling, and one indicator 27 for underscheduling. In addition, one indicator 28 is provided which can identify days with special events.

List of reference numbers

| | |
|---|---|
| 1 | duty roster on a common user interface |
| 2 | forecast module |
| 3 | interface for importing data |
| 4 | data on holidays and fairs |
| 5 | market place |
| 6 | unscheduled hour requirements |
| 7 | time accounts of employees |
| 8 | absence data |
| 9 | schedule data for the future |
| 10 | entry data |
| 11 | formulas, department-specific |
| 12 | projected hours |
| 13 | employee data |
| 14 | data on hours worked in the past |
| 15 | hotel management/reservation data |
| 16 | personnel data |
| 17 | time-recording data |
| 18 | budgeting data |
| 19 | personnel number |
| 20 | name |
| 21 | time account |
| 22 | working hours |
| 23 | free days |
| 24 | absence |
| 25 | indicator for over-scheduling |
| 26 | indicator for optimal scheduling |
| 27 | indicator for under-scheduling |
| 28 | indicator for special events |

### Statement Based on PCT Art. 19

Response to the written opinion of the International Search Authority dated Apr. 11, 2008 in regard to the above-referenced international patent application:

In the amendments of the claims submitted in accordance with PCT Art. 19, the features of the original Claim 2 were incorporated in the method step a) so that this now relates to “storing the employee data (13), including individual employee properties, by importing the employee data through an interface from a database of the personnel department (16), and/or manual entry.”

The features of the original Claim 3 were incorporated in method step c) of claim 1, so that this step now comprises “immediately entering absences (8) and integrating absence data of the employees into the data-processing system through a time-recording system (17), and/or manual entry of this absence data.”

The document DE 101 36 054 A1 that was already referenced in the introduction to the description of the present patent application represents the closest pertinent prior art. Based thereon, the problem to be solved by this invention was to provide a method of optimizing the determination of actual personnel requirements to create a duty roster, wherein a uniform duty roster organization for multiple departments is provided, the data can be retrieved at any time, and an automatic adjustment of the capacity utilization of a service-oriented operation can be effected.

This problem is solved according to the invention by the method according to Claim comprising the method steps h) through f). To this end, what had to be discovered in particular is that employee data from a database of the personnel department, as well as absence data on the employees, can be integrated through a time-recording system into the data-processing system. What is furthermore of critical importance is that data on the current occupancy can be simultaneously utilized through an interface in a reservation program and in a budgeting program, with the result that it becomes possible to determine the actual current personnel requirement, or that for a specifiable period of time, and to display this graphically. It is only by implementing the referenced method steps that it becomes possible to really optimize the determination of actual personnel requirements for the creation of a duty roster. This method can be implemented on a completely automated basis, wherein appropriate warning messages can be displayed in response to the determined overstaffing and/or understaffing (see the present Claim 3).

The critical aspect is thus the integration of data from the personnel department, from a time-recording system, and from a reservation program. The determination, to be effected according to method step e), of the actual current personnel requirement, or that needed for a specifiable time period, is effected with the aid of department-specific formulas and by utilizing the data from method steps a) through d).

The technical aspect of the method according to Claim 1 can also not be denied since in particular the method steps relating to the integration of data through appropriate interfaces from a database of the personnel department, from a time-recording system, and from a reservation program are without doubt of a technical nature. A the same time, the designated intended use of technical items to also include business activities does not rule out their patentability.

1-9. (canceled)

10. A method of optimizing the determination of actual personnel requirements for the creation of a duty roster of a hotel, a guesthouse, and/or a restaurant with the aid of a data-processing system having a memory, a processor, at least one input unit, at least one interface to a reservation program, and a budgeting program, as well as a common user interface, wherein the method comprises the following steps:
a) storing employee data, including individual employee properties, by importing the employee data through an interface from a database of the personnel department or manual entry;
b) storing department-specific needs or event-dependent requirements;
c) immediately entering absence data and integrating attendance data on the employees into the data-processing system through a time-recording system or by manual entry;
d) utilizing data on current occupancy through an interface to a reservation program and to a budgeting program;
e) determining the actual, current personnel requirement or that required for a specifiable time period, based on the required employee hours per department with the aid of department-specific formulas and utilizing the data from method steps a) through d); and
f) generating a report on the common user interface.

11. The method defined in claim 10 wherein the department-specific requirements stored in the database or event-dependent requirements of the given department can be modified as necessary.

12. The method defined in claim 10, further comprising the step of
displaying warning messages when overstaffing or understaffing is determined.

13. The method defined in claim 10 wherein the language of the user interface can be freely selected by a given user.

14. The method defined in claim 10, further comprising the step of
displaying calendar summaries for absent employees on the user interface by department, name, or personnel number.

15. The method defined in claim 10 wherein new manual employee profiles can be added to the database, or existing employee profiles can be supplemented to include additional individual employee properties.

16. The method defined in claim 10 wherein the data-processing system further includes an interface to the Internet.

17. A computer program comprising programming code to execute all of the method steps according claim 10 when the program is run in a computer.

18. A computer program comprising computer code that is stored on a machine-readable medium to execute the method steps according to claim 10 when the program is run in a computer.
